(19) United States
(12) Patent Application Publication
(10) Pub. No.: US 2008/0236287 A1
(43) Pub. Date: Oct. 2, 2008

(54) Method And Apparatus For Detecting A Crack In A Pipeline From Inside The Pipeline With Ultrasound

(75) Inventors: Robert Van Agthoven, Berkel En Rodenrijs (NL); Bernard Spree, Gouda (NL); Wouter De Waal, 's-Gravenhage (NL)

Correspondence Address: JACOBSON HOLMAN PLLC, 400 SEVENTH STREET N.W., SUITE 600, WASHINGTON, DC, 20004, US

(73) Assignee: RÖNTGEN TECHNISCHE DIENST B.V., NC Rotterdam (NL)

(21) Appl. No.: 11/631,338

(22) PCT Filed: Jul. 1, 2005
(86) PCT No.: PCT/NL2005/000467

§ 371 Date: Jan. 9, 2008

(30) Foreign Application Priority Data
Jul. 1, 2004 (NL) 1026538

(51) Int. Cl. G01N 29/04

(52) U.S. Cl. 73/623

(57) ABSTRACT

A method for detecting a crack in a pipeline from an inside of the pipeline, wherein, with the aid of at least one ultrasonic transmitter in the pipeline, successively ultrasonic pulses are transmitted in a direction of an inner wall of the pipeline and wherein, with the aid of at least one ultrasonic receiver in the pipeline, reflections of the ultrasonic pulses on the pipeline are received. The ultrasonic transmitter and the ultrasonic receiver are mutually separated at a distance from each other, wherein the ultrasonic transmitter and the ultrasonic receiver are moved together along the inner wall in tangential direction of the pipeline and at a distance from the inner wall for scanning the pipeline. The pipeline is filled with a liquid such as water for obtaining an immersion between the ultrasonic transmitter, the ultrasonic receiver and the inner wall of the pipeline.

The invention relates to a method for detecting a crack in a pipeline from an inside of the pipeline, wherein, with the aid of at least one ultrasonic transmitter in the pipeline, successively ultrasonic pulses can be transmitted in a direction of an inner wall of the pipeline and wherein, with the aid of at least one ultrasonic receiver in the pipeline, reflections of the ultrasonic pulses on the pipeline are received.

The invention further relates to an assembly of a pipeline and a system for detecting a crack in the pipeline from an inside of the pipeline wherein the system is provided with a carriage which is operatively transported inside the pipeline in a longitudinal direction of the pipeline coinciding with a driving direction of the carriage and wherein the system is further provided with at least one ultrasonic transmitter and at least one ultrasonic receiver mounted on the carriage. In addition, the invention relates to a system of the assembly.

Such a method, assembly and system are known per se.

In pipelines such as for instance gas pipelines, the problem of cracking can occur. Such cracking has recently been observed in pipelines which had been rolled up before being laid. These pipelines were, in addition, provided with zinc anodes attached on the pipeline on an outside of the pipeline by means of welding in order to prevent oxidation of the pipeline. Now it appears that particularly in areas of the pipeline where the pipeline is provided with the anode, cracking can take place. These cracks particularly extend from an outer wall of the pipeline in radial direction to an inner wall of the pipeline. In addition, these cracks particularly extend in tangential direction of the pipeline.

It is of the utmost importance that these cracks in such gas lines can be detected quickly and accurately so that repair can be done. Because these pipelines are usually underground or on a seabed, it is not practicable to carry out an inspection from an outside of the pipeline. A drawback of the known methods, assemblies and systems for detecting cracks in a pipeline from an inside of the pipeline is that this detection takes up very much time. With the known detections, the ultrasonic transmitter and the ultrasonic receiver are moved in contact with and along an inner wall of the pipeline in order to thus scan the wall of the pipeline. This scanning movement takes up very much time.

The invention contemplates providing a method whereby cracks in a pipeline can quickly and adequately be detected from an inside of the pipeline.

To this end, the method according to the invention is characterized in that the ultrasonic transmitter and the ultrasonic receiver are mutually separated at a distance from each other, while the ultrasonic transmitter and the ultrasonic receiver are moved together along the inner wall in tangential direction of the pipeline and at a distance from the inner wall for scanning the pipeline, while the pipeline is filled with a liquid such as water for obtaining an immersion between the ultrasonic transmitter, the ultrasonic receiver and the inner wall of the pipeline for the purpose of scanning, while the presence of a crack is detected on the basis of points in time at which reflections of the successive ultrasonic pulses are received.

Because the pipeline is filled with water for obtaining an immersion between the ultrasonic transmitter, the ultrasonic receiver and the inner wall of the pipeline, a scanning movement can be carried out relatively fast.

When such a scanning movement is carried out, for instance the point in time at which a reflection of an inner wall is detected and a reflection of an outer wall is detected is registered. Further, it is the case that a diffraction occurs on the edges of a crack, if any. Any diffraction, which is in fact a reflection of an ultrasonic pulse, can also be detected. The point in time at which these reflections occur can also be registered. If, therefore, in addition to the expected reflections on the inner wall and the outer wall, other reflections occur, this is a strong indication of cracking. If, in addition to the reflections on the inner and outer wall, two additional reflections are detected, these will often indicate a starting point and an end point of a crack, viewed in radial direction of a wall of the pipeline. In the case of cracking from an outside of the pipeline, as indicated hereinabove, no separate reflection can be detected of the origin of the crack since it coincides with the outer wall of the pipeline which already generates a reflection. What can be detected then is a reflection of an end point of the crack, viewed in radial direction. The point in time at which this reflection is registered with respect to the reflections of the inner wall and/or the outer wall is a measure for a position of the end of such a crack. In particular, these cracks extending from an outer wall of the pipeline in radial direction to an inner wall of the pipeline can thus be detected. More generally, other cracks in the interior of the wall of the pipeline, which cracks do not extend to the outer wall and/or to the inner wall, can thus be detected as well.

It particularly holds true that the ultrasonic transmitter and the ultrasonic receiver are separated from each other in a longitudinal direction of the pipeline for detecting cracks of which at least a part extends in a tangential direction of the pipe. Here, it preferably holds true that the beam width of a wave transmitted by the ultrasonic transmitter in a direction in which the ultrasonic transmitter and the ultrasonic receiver are separated from each other is larger than a beam width in a direction perpendicular to the direction in which the ultrasonic transmitter and the ultrasonic receiver are separated from each other. Thus, in tangential direction of the pipeline, a scanning movement can be carried out whereby a high resolution is obtained in the tangential direction for determining the starting point and the end point of a crack extending in tangential direction (and in radial direction as described hereinabove).

This scanning movement in tangential direction can be carried out relatively fast due to the use of water so that there is no direct contact between the ultrasonic transmitter and the ultrasonic receiver on the one hand and the inner wall of the pipeline on the other hand. Further, it preferably holds true that the ultrasonic transmitter and the ultrasonic receiver are also moved in a longitudinal direction of the pipeline. The movement in radial direction and the movement in longitudinal direction can be carried out alternately. However, preferably these movements are carried out simultaneously. The result is that the ultrasonic transmitter and the ultrasonic receiver move along a helix extending in the longitudinal direction of the pipeline. Here, it particularly holds true that a width of a transmitted ultrasonic pulse near the inner wall of the pipeline in a direction from the ultrasonic transmitter to the ultrasonic receiver is larger than the distance between neighboring positions in which the ultrasonic transmitter and the ultrasonic receiver are located when they always take up a same tangential position during scanning. In the case that the ultrasonic transmitter and the ultrasonic receiver move along the helix, this in fact means that a beam width of a transmitted ultrasonic pulse near the inner wall of a pipeline in a direction from the ultrasonic transmitter to the ultrasonic receiver is larger than the pitch of the helix. In successive rotations, then overlap will occur of successively scanned areas of the pipeline.

It particularly holds true that the ultrasonic transmitter and the ultrasonic receiver are transported in the pipeline at a relatively high transport speed to predetermined areas where cracks are expected, while, during scanning of the areas, the ultrasonic transmitter and the ultrasonic receiver are moved in the longitudinal direction of the pipeline at an average scanning speed which is lower than the transport speed. Here, these areas can be determined by the positions of the anodes. Because the cracking takes place near the anodes, thus just areas where the cracking can be expected can be scanned. The result is that that the pipeline can be analyzed for cracking at a still higher speed. It particularly holds true that use is made of a carriage which is transported inside the pipeline in a longitudinal direction of the pipeline, which carriage is provided with a rotor which is rotated about a rotational axis extending in the longitudinal direction of the pipeline, while the ultrasonic transmitter and the ultrasonic receiver are mounted on the rotor. Here, it preferably holds true that further a first ultrasonic transmitter/receiver is mounted on the rotor whereby, with the aid of the first ultrasonic transmitter/receiver, ultrasonic pulses are transmitted in a radial direction of the pipeline and where, on the basis of reflections on the pipeline of the ultrasonic pulses transmitted by the first ultrasonic transmitter/receiver, which reflections are received with the first ultrasonic transmitter/receiver, it is determined whether the rotational axis is in a center of the pipeline. It further preferably holds true in that case that, on the basis of reflections on the pipeline of the ultrasonic pulses transmitted by the first ultrasonic transmitter/receiver, which reflections are received with the first ultrasonic transmitter/receiver, it is checked whether an area is scanned where an anode is present by detecting the presence of welds whereby the anode is attached on the pipeline.

The invention will now be explained in more detail with reference to the drawing, in which:

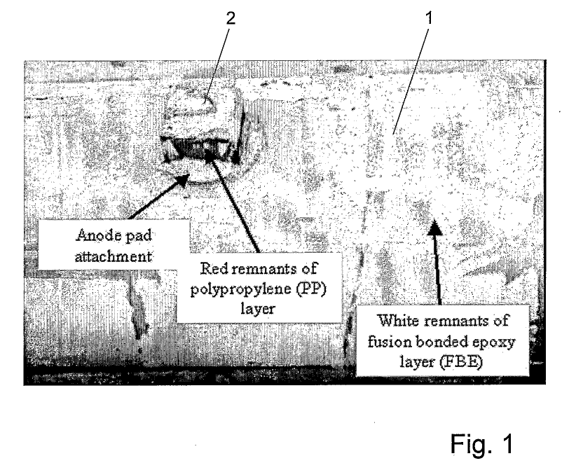

FIG. 1 shows an image of a pipeline, in this example a gas pipeline, which is provided with a zinc anode;

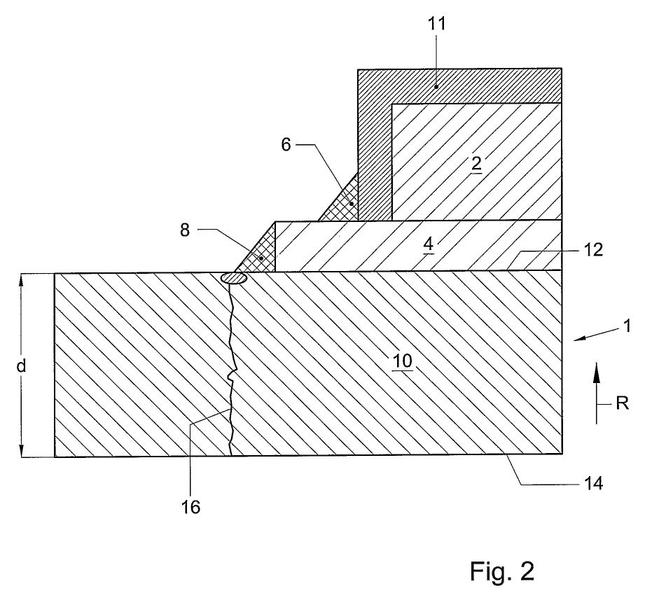

FIG. 2 schematically shows a cross section of a part of the pipeline and the zinc anode according to FIG. 1;

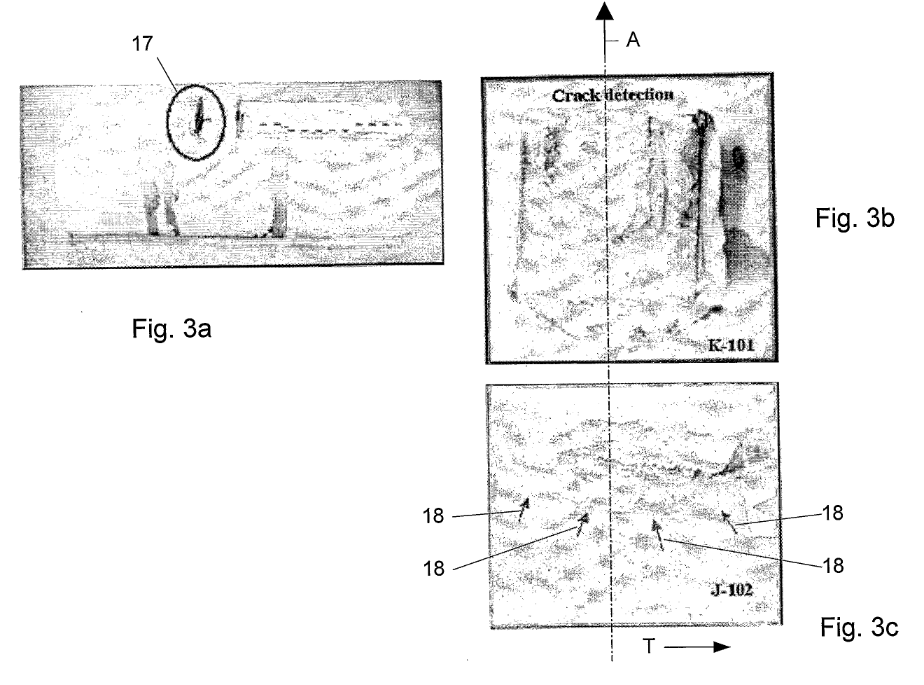

FIG. 3a shows an image of a pipeline according to FIG. 1 where cracking has taken place;

FIG. 3b shows a top plan view of the anode of the pipeline according to FIG. 3a;

FIG. 3c shows a view of the anode of the pipeline according to FIG. 3a;

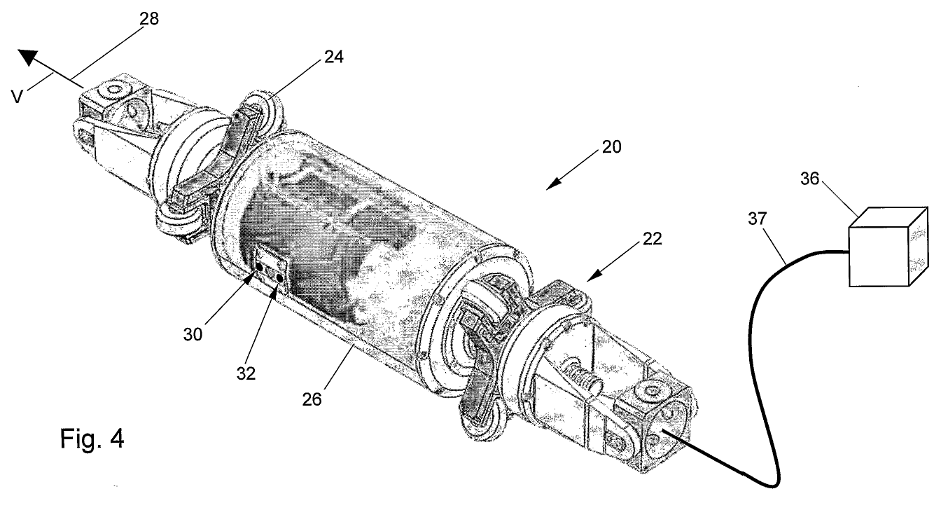

FIG. 4 schematically shows a possible embodiment of a system according to the invention for detecting a pipeline;

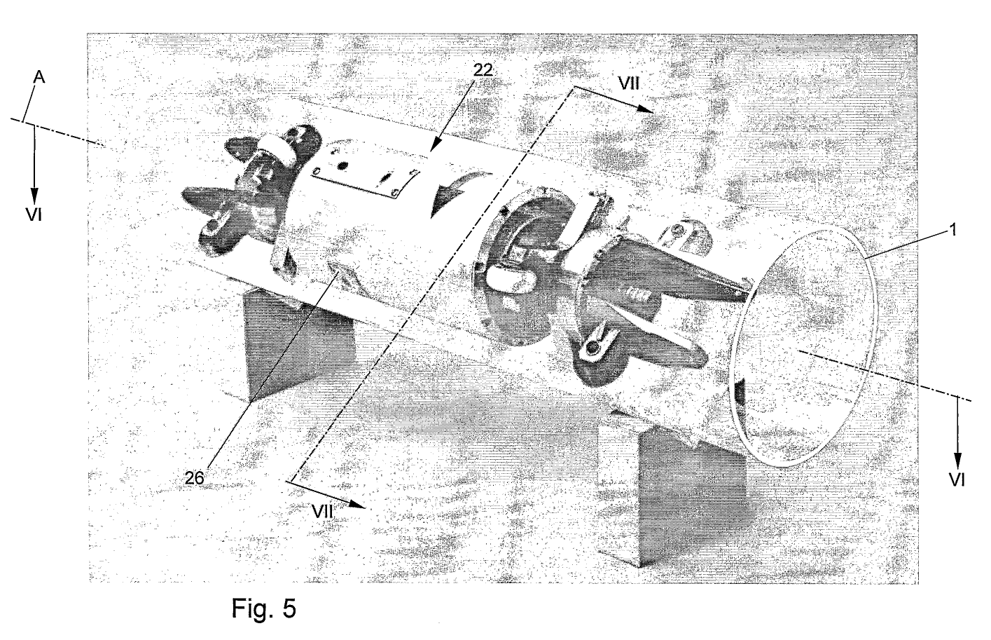

FIG. 5 schematically shows an assembly of a pipeline (in transparent view) in which a carriage of the system according to FIG. 4 is included;

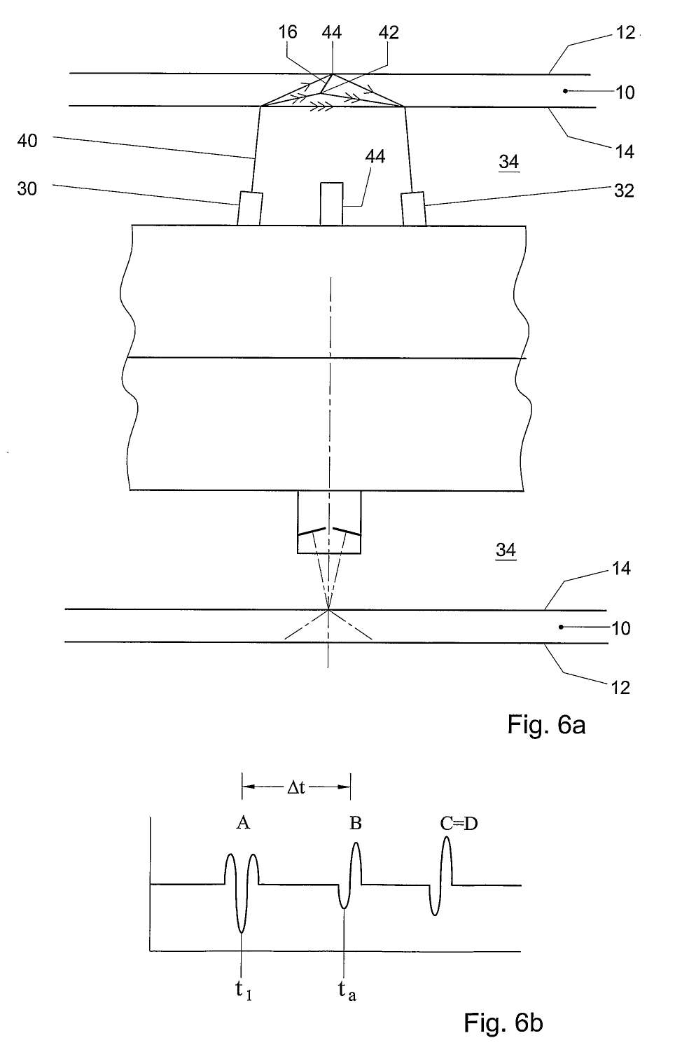

FIG. 6a shows a cross section of in a longitudinal direction of a pipeline of a rotor of a carriage according to FIG. 5;

FIG. 6b shows a possible receiving signal obtained with the apparatus according to FIG. 6a;

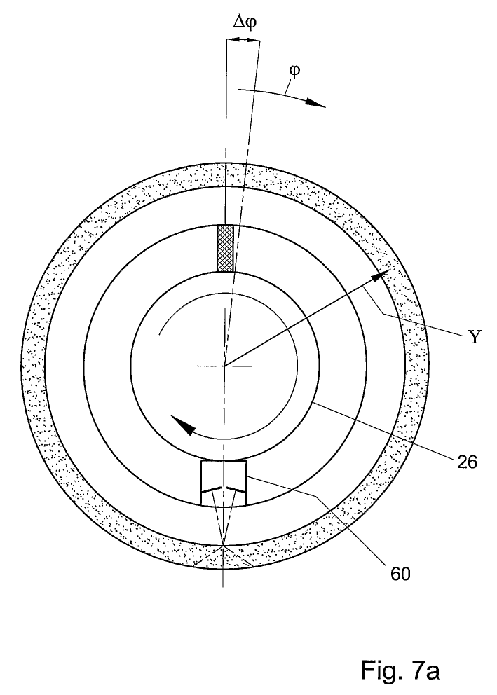

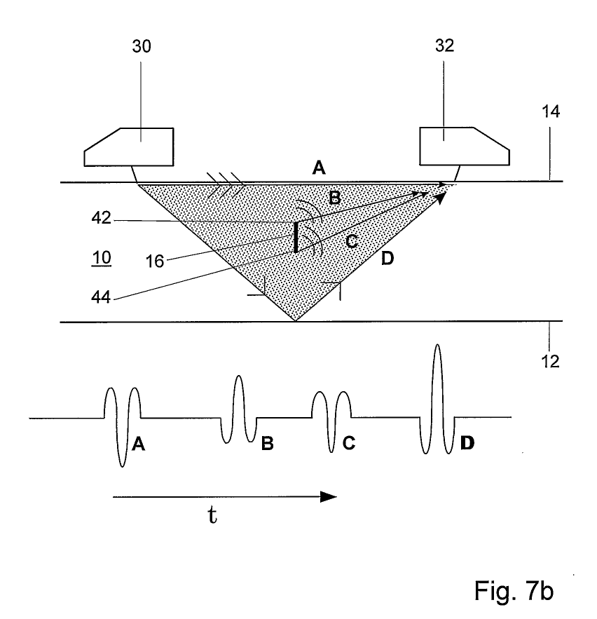

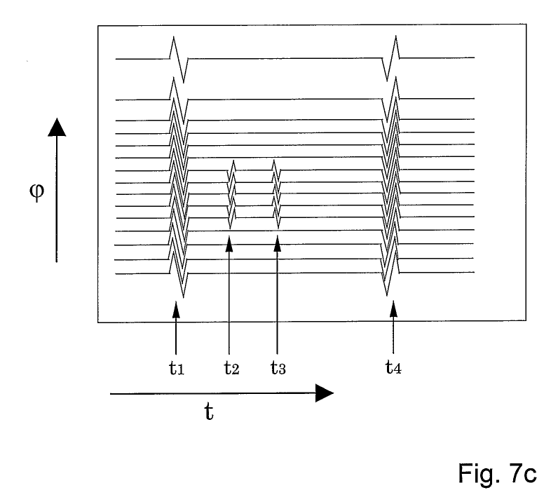

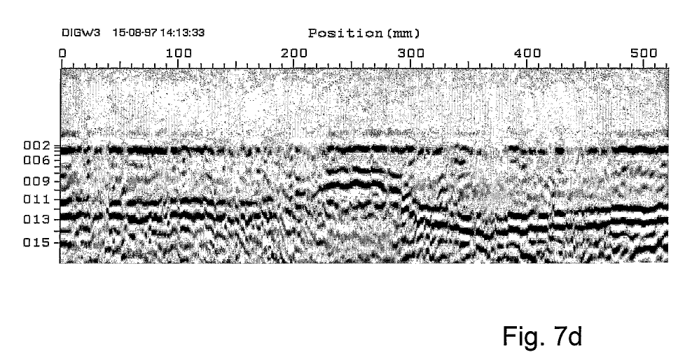

FIG. 7a shows a cross section in radial direction of the pipeline of a rotor of the carriage according to FIG. 5;

FIG. 7b schematically shows a possible receiving signal;

FIG. 7c schematically shows a number of successive receiving signals obtained on the basis of successive transmitted ultrasonic pulses;

FIG. 7d shows a graphic representation which can be obtained on the basis of the signals according to FIG. 7c;

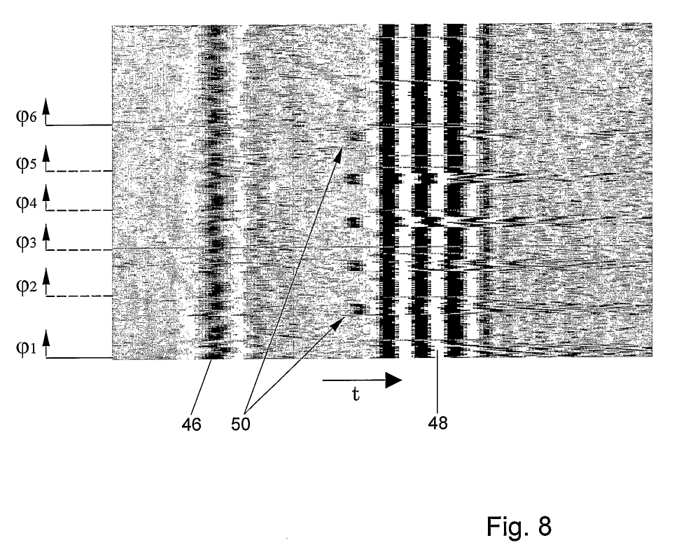

FIG. 8 shows a graphic representation which can be obtained on the basis of signals according to FIG. 7c;

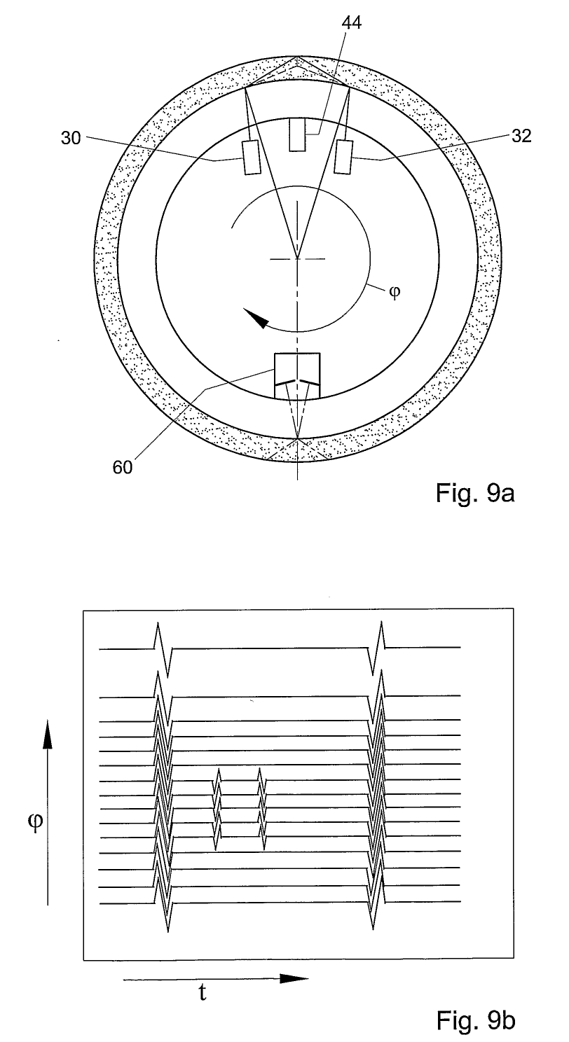

FIG. 9a shows a cross section in a tangential direction of the pipeline of an alternative embodiment of a carriage according to FIG. 5;

FIG. 9b shows a number of successive receiving signals which can be obtained on the basis of successive transmitted ultrasonic pulses with the aid of the apparatus according to FIG. 9a; and

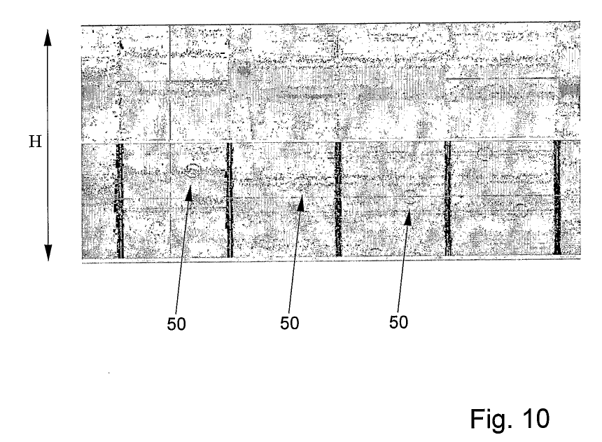

FIG. 10 shows a graphic representation obtained on the basis of a transmitter/receiver of the system according to FIG. 6.

In FIG. 1, reference numeral 1 designates a pipeline. In this example, the pipeline 1 is a gas pipeline which is, for instance, in use, on the floor of a sea or a lake. The pipeline 1 is provided with a zinc anode 2 known per se. FIG. 2 shows a cross section in radial direction of a part of the pipeline, on which part the zinc anode 2 is attached. As FIG. 2 shows, the zinc anode 2 is attached on a plate 4, the zinc anode 2 being attached on the plate 4 with the aid of a weld 6 and the plate 4 being attached on a wall 10 of the pipeline with the aid of a weld 8. On the zinc anode 2, a layer 11 of carbon steel has been applied. In this example, in FIG. 2, d designates the thickness of a wall of the pipeline. Reference numeral 12 designates an outer wall of the pipeline and reference numeral 14 designated an inner wall of the pipeline. In this example, the plate 4 is manufactured from AISI 316 while, as already said, the anode 2 is manufactured from zinc. The pipeline according to FIGS. 1 and 2 has been in a rolled-up condition before it was laid. In this example, in this rolled-up condition, a crack 16 appears to have been formed which extends in radial direction R of the wall 10. The crack appears to have been formed where the weld 8 extending in tangential direction is attached on the outer wall 12. So the crack 16 extends in tangential direction T (see FIGS. 3b, 3c) of the pipeline. This crack has probably been formed during the rolling up of the pipeline before it was placed and unrolled again. When the crack has been formed during rolling up, it is possibly visible from the outside of the pipeline. However, when the pipeline is unrolled again, the crack is squeezed up again and will be completely invisible, at least to the eye. If, as is the case in this example, the pipeline 1 has been laid underwater, there is no point to inspection of the pipeline from the outside. Firstly, visual inspection does not help and secondly, in that case, diving should be done.

In FIG. 3a, it is indicated in an ellipse 17 where cracking has take place. In FIGS. 3b and 3c, the arrow A indicated the axial direction of the axis and the cracking is indicated by the arrows 18.

In order to be able to detect the cracks, use is made of a system 20 as shown in FIG. 4. The system is provided with a carriage 22 which can operatively be included in a pipeline 1. The latter is shown in FIG. 5, where, by way of illustration, the pipeline 1 is not a real metal pipeline, but a transparent pipeline 1 manufactured from plastic. The carriage 22 is provided with wheels 24 which provide the carriage with a driving direction V. The driving direction V coincides with the longitudinal direction i.e. the axial direction A of the pipeline 1. The carriage is provided with a rotor 26 arranged for operatively rotating about a rotational axis 28 extending in the driving direction V. The system 20 is further provided with at least one ultrasonic transmitter 30 and at least one ultrasonic receiver 32 which are mounted on the rotor 26. The system is arranged for successively transmitting ultrasonic pulses in a direction of the inner wall 14 of the pipeline 1 with the aid of the ultrasonic transmitter 30 in the pipeline and for receiving reflections of the ultrasonic pulses on the pipeline with the aid of the ultrasonic receiver in the pipeline. Here, the ultrasonic transmitter and the ultrasonic receiver and the rotation of the rotor are moved together along the inner wall in tangential direction T of the pipeline and at a distance from the inner wall for scanning the pipeline. This distance is, for instance, larger than 0.5 or 1 cm. The distance is such that there is no direct contact between the transmitter 30 and the receiver 32 on the one hand and the inner wall 14 on the other hand. Here, it is provided that, during scanning, the pipeline 1 is filled with liquid such as water 34 for obtaining an immersion between the ultrasonic transmitter and the ultrasonic receiver on the one hand and the inner wall 14 of the pipeline 1 on the other hand for the purpose of scanning. All this is clearly shown in FIG. 6. If the pipeline 1 is a gas line, this therefore means that, before the inspection of the pipeline starts, this line is filled with water.

As FIG. 4 shows, the system 20 is further provided with signal processing means 36 which are inter alia connected with the ultrasonic transmitter and the ultrasonic receiver of the carriage 22. In this example, this connection is realized with the aid of a cable 37. However, wireless connections are possible as well. For the purpose of this connection, the carriage may, for instance, be provided with sliding contacts in a manner known per se. The signal processing means 36 may comprise inter alia a computer and a screen.

With the aid of the assembly described up to this point, the following method can be carried out.

With the aid of the ultrasonic transmitter, successive ultrasonic pulses are performed. In this example, the ultrasonic transmitter and the ultrasonic receiver are separated from each other in the driving direction V of the carriage, that is, in this example in a longitudinal direction A of the pipeline. FIG. 6a shows the ultrasonic beam 40 transmitted by the ultrasonic transmitter 30. The ultrasonic beam 40 propagates through the water 34 which acts as a suitable transmission medium here. At a certain point, the ultrasonic beam 40 reaches the inner wall 14 of the pipeline. Then the ultrasonic beam will propagate along the inner wall 14. This is a so-called creeping wave. This is a transversal wave, then. This creeping wave will be received by the ultrasonic receiver 32. This transversal wave is indicated by a triple arrow in FIG. 6a. Because this creeping wave is received first, thus first a reflection of the inner wall is obtained. Another part of the ultrasonic pulse will propagate inside the wall 10 as a longitudinal wave and is reflected on the outer wall 12 of the wall 10. The direction of this beam is indicated by a single arrow in FIG. 6a. The reflection of the pulse on the outer wall 12 will thus be detected at a later point in time. All this is also schematically shown in FIGS. 6a and 7b. In FIGS. 6a and 7b, A indicates the reception of the reflection (echo) of the transmitted ultrasonic pulse on the inner wall and D the reflection of the transmitted pulse on the outer wall. As is indicated in FIG. 7b, the starting point 42 of a fault extending in radial direction R can result in a diffraction of the transmitted ultrasonic pulse. This diffraction in fact causes a reflection of the pulse indicated by B in FIGS. 6a and 7b. Viewed in radial direction, the fault of FIG. 7b ends in an end 44 which also causes diffraction. This end 44 corresponds with the reflection indicated by C in FIG. 7b. If cracking of the outer surface arises, point 44 will coincide with the outer wall 12. As a result, echo C will coincide with echo D in FIG. 7b. In FIGS. 6a and 6b, a situation is shown in which the point 44 is indeed located near the outer wall 12 while the point 42 is located somewhere in the center of the material of the inner wall.

It will be clear that, on the basis of the points in time at which the reflections of an ultrasonic pulse are received, the presence of a crack can be detected since, in FIG. 7b, the reflections B and C will be an indication of the presence of a crack. If, as shown in FIG. 6b, the point in time at which the reflection is received of a transmitted pulse on the inner wall of the pipeline is taken as a reference, then the point in time ΔT=t₂−t₁ is a measure for the radial position of the end 44 of the crack which originates in the outer wall 12. Thus, t₂ is equal to the point in time at which the reflection has been received on the basis of the diffraction of the transmitted pulse at the end 42 of the crack 16.

Because the rotor 26 rotates, the ultrasonic transmitter and the ultrasonic receiver will be moved at a distance from the inner wall and in tangential direction of the pipeline for scanning the inner wall. This means that, at the moment that a next ultrasonic pulse is transmitted, the rotor has rotated over an angle Δφ (see FIG. 7a). If the crack extends in tangential direction, as can be expected, then, in addition to the reflection on the inner wall and the outer wall, the end of the crack will also yield a reflection. The start of the crack will also yield a reflection if it does not coincide with the outer wall of the line. FIG. 7c shows such a situation as an example. Here, separated from one another in vertical direction, a number of receiving signals generated with the aid of the ultrasonic receiver 32 are registered. The receiving signals obtained in successive positions of the rotor, i.e. positions in which, each time, the rotor has rotated over a distance Δφ, are respectively arranged one above the other in FIG. 7c. In this example, the receiving signal obtained last is placed above the receiving signal obtained second last. Here, the signal processing means 36 have ensured that the points in time at which a reflection occurs on the inner wall each time coincide. The result is that the points in time t₄ at which a reflection occurs on the outer wall each time coincide as well. It can be seen that, with six successive transmitted pulses, in addition to at point in time t₁ and point in time t₄, reflections are also measured at point in time t₂ and point in time t₃. Here, points in time t₂ and t₃ correspond with the start and the end, respectively, of a crack extending in radial direction of the pipeline. The difference between t₃ and t₂ is a measure for the length of the crack in radial direction. Because the crack itself is measured with approximately six successive pulses, while, with the six successive pulses, the rotor has moved over a distance of six times Δφ, this also means that the crack extends in tangential direction over a tangential angle which is equal to six times Δφ. Then the length of the crack in tangential direction is about six times Δφ×Y, in which Y is approximately equal to half of the inner diameter or half of the outer diameter of the pipeline (or an average thereof).

It particularly holds true that the beam width of a wave transmitted by the ultrasonic transmitter in a direction in which the ultrasonic transmitter and the ultrasonic receiver are separated from each other is larger than a beam width in a direction perpendicular to the direction in which the ultrasonic transmitter and the ultrasonic receiver are separated from each other. In the present example, this means that a beam width of a pulse transmitted by the ultrasonic transmitter in a longitudinal direction of the pipeline is larger than a width of the beam in tangential direction of the pipeline. In other words, it holds true in this example that a beam width of a wave transmitted by the ultrasonic transmitter in a driving direction of the carriage is larger than the beam width perpendicular to the driving direction of the carriage.

The result is that, in this example, the length of the crack in tangential direction as well as the depth of the crack can accurately be determined. The length of the crack in tangential direction is determined by the number of successive times that a crack is detected when the ultrasonic transmitter successively transmits the pulses. As said, then the number of times times Δφ is an indication of the length of the crack in tangential direction. The length of the crack in radial direction can be determined on the basis of the points in time mentioned.

In FIG. 7d, the successive signals of FIG. 7c are represented by in fact rotating the signals according to FIG. 7c 90° counterclockwise and compressing them and using image processing so that the reflections become white. All this can be carried out by the signal processing means. Then an operator can analyze this image and determine whether cracking has taken place.

Now the carriage, and thereby the ultrasonic transmitter and the ultrasonic receiver, is also moved in a longitudinal direction of the pipeline. This may, for instance, be carried out by having the carriage form a seal with an inside of the pipeline. By now generating pressure on one side of the carriage, for instance with the aid of the water, which pressure is larger than the pressure on the other side of the carriage, the carriage will start to drive in the driving direction under the influence of the pressure difference. In this example, the rotation of the rotor and the driving of the carriage in the driving direction take place simultaneously so that the ultrasonic transmitter and the ultrasonic receiver are moved together along a helix extending in the longitudinal direction of the pipe. Here, it particularly holds true that a width of a transmitted ultrasonic pulse near the inner wall of the pipeline in a direction from the ultrasonic transmitter to the ultrasonic receiver is larger than the distance between neighboring positions in which the ultrasonic transmitter and the ultrasonic receiver are located when they always take up the same tangential position during scanning. In other words: in this example, it holds true that a width of a transmitted ultrasonic pulse near the inner wall of the pipeline in a direction from the ultrasonic transmitter to the ultrasonic receiver is larger than the pitch of the helix. The result is that the area that is scanned with the aid of a rotating movement of the rotor partly overlaps with the area that is scanned by a next rotating movement of the rotor. In this manner, one knows for sure that the complete relevant part of the pipeline can be scanned.

Further, it particularly holds true that, with the aid of the carriage, the ultrasonic transmitter and the ultrasonic receiver can be transported in the pipeline at a relatively high transport speed to predetermined areas where cracks are expected, while, during scanning of the respective areas, the ultrasonic transmitter and the ultrasonic receiver are moved in the longitudinal direction of the pipeline at an average scanning speed which is lower than the transport speed. In this example, this average scanning speed is the pitch of the helix divided by the time needed to let the rotor rotate over 360°. In this example, the areas are determined by the positions of the anodes. It is thus possible to move the carriage at a relatively high speed to an area where an anode is present. This is exactly the area where a crack can be expected. Once the carriage has arrived in the area, its speed in the longitudinal direction of the pipeline is reduced so that it propagates in the longitudinal direction at a speed equal to the transport speed.

As discussed hereinabove, it holds true that the size and the position of at least a part of the crack in radial direction of the pipeline can be determined on the basis of the points in time mentioned. Here, it holds true that the point in time of the reflection on the inner wall can be taken as a reference point in time, while the points in time of the other reflections are determined with respect to the reference point in time for further processing. It is also possible that the point in time of the reflection on the outer wall is taken as a reference point in time, while the points in time of the other reflections are determined with respect to the reference point in time for further processing. All this has been discussed with reference to FIG. 7c.

It further holds true that the position and/or the size of at least a part of the crack in tangential and/or longitudinal direction of the pipeline is determined on the basis of momentary positions of the ultrasonic transmitter and the ultrasonic receiver in the pipeline in which they are located inside the pipeline when the ultrasonic reflections of the crack are received. In the foregoing, it has been set forth that, particularly in tangential direction, the length of the crack can be determined accurately given the beam widths used. In this example, the length and position of a crack in the longitudinal direction of a pipeline can be determined with a resolution no larger than the beam width in the longitudinal direction or the pitch D of the helix (the largest determines the resolution).

The signal processing means 36 may for instance be provided with a screen for delivering an image as shown in FIG. 8. In FIG. 8, the receiving signals are plotted as this is also shown in FIG. 7c, where successive receiving signals obtained on the basis of successive transmitted pulses are placed one above the other. Here, in FIG. 8, the arrow φ1 indicates the receiving signals placed one above the other which have been obtained during scanning of a first quadrant (for instance 0<φ<90; see FIG. 7a) of the pipeline. The arrow φ2 again indicates the successive receiving signals obtained during scanning of the first quadrant upon a next complete scan of the rotor. The arrow φ3 indicates the successive receiving signals obtained upon the next complete scan of the rotor after that. In other words: in FIG. 8, the successive receiving signals are indicated which have been obtained upon, in this example, six times carrying out a complete scan of the rotor, where, however, the receiving signals of a second, third and fourth quadrant (90<φ<360°) have each been left out. This is not essential; in this example, however, all this has been carried out to be able to completely utilize the signal processing capacity of the signal processing means 36 for the first quadrant. In the direction of the horizontal axis, the time t and thus the depth with respect to, for instance, the outer wall 12 is plotted. The first vertical black-and-white band 46 is formed by reflection on an inside of the wall. The second, very clearly present, vertical black-and-white band 48 is obtained by reflection on the outside of the wall. It can be seen that, with a number of successive complete scans of the rotor, an additional reflection 50 is present. The point in time t2 at which the reflection occurs is a measure for the depth to which the crack extends as discussed with reference to FIG. 6b. The number of successive receiving signals in which the reflection can be seen during scanning of a quadrant is a measure for the length in tangential direction of the crack. Then the length is the number of receiving signals times Δφ, in which Δφ is the distance over which the rotor is rotated during the period of time between the transmission of two successive pulses. The number of times that the reflections 50 are imaged in FIG. 8 (5 times in this example) means that the reflection is each time measured over a length of the pipeline which is equal to 5 times the pitch D of the helix. Because, in this example, the width of the beam is relatively large in the longitudinal direction of the pipeline and the crack is expected to extend in tangential direction, it is rather a measure for the width of the beam. This is of course not essential because it can also be realized that the beam width is also limited in this direction for obtaining information about a distance over which a crack could extend in the longitudinal direction of the pipeline. This can already be realized very easily by separating the ultrasonic transmitter and the ultrasonic receiver from each other in a tangential direction of the pipeline. It is also possible that the ultrasonic transmitter and the ultrasonic receiver are separated from each other both in the tangential direction and in a longitudinal direction of a pipeline. In that case, when the ultrasonic transmitter has a beam width as described hereinabove, the length of the crack can be determined accurately both in the tangential direction and in the longitudinal direction of the pipeline with the exception of the case when the longitudinal direction of the crack extends in the direction in which the ultrasonic transmitter and the ultrasonic receiver are separated from each other. However, it is also possible to use a second ultrasonic transmitter and a second ultrasonic receiver, the second ultrasonic transmitter 30′ and the second ultrasonic receiver 32′ being separated from each other in a tangential direction and the first ultrasonic transmitter 30 and an ultrasonic receiver 32 being separated from each other in the longitudinal direction of the pipeline. The beam width of the ultrasonic transmitter 30′ in the direction from the ultrasonic transmitter 30′ to the ultrasonic receiver 32′ is then again larger than the beam width of the ultrasonic transmitter 30′ perpendicular to that direction. By now taking measurements with both pairs 30,32; 30′,32′, cracking can optimally be detected in any direction. Here, it is further conceivable that the ultrasonic receiver 32,32′ is combined in one receiver, while alternately pulses are transmitted by the transmitter 30′ and the transmitter 30 on the basis of time-sharing.

It particularly holds true in this example that, on the rotor, further a first ultrasonic transmitter/receiver 44 is mounted whereby, with the aid of the first ultrasonic transmitter/receiver 44, ultrasonic pulses can be transmitted in radial direction of the pipeline while, on the basis of reflections, on the pipeline of the ultrasonic pulses transmitted by the first ultrasonic transmitter/receiver, which reflections were received with the first ultrasonic transmitter/receiver 44, it is determined whether the rotational axis is in the center of the pipeline. In this example, the first ultrasonic transmitter/receiver 44 is a zero-degree scanner known per se. The frequency at which the pulses are transmitted by the ultrasonic transmitter/receiver 44 may, for instance, be equal to but also smaller than the frequency at which pulses are transmitted with the aid of the ultrasonic transmitter 30. If the rotational axis of the rotor is in the center of the pipeline, the period of time after transmitting a pulse until a reflection on the inner wall is received will not vary with the rotating movement of the rotor. If the rotational axis is not in the center of the pipeline, then this point in time, which is the measure for the distance from the ultrasonic transmitter/receiver 44 to the inner wall 14, will vary according to a sinus, the period of the sinus coinciding with one rotating movement of the rotor.

In this example, the signal processing means 36 are arranged for being able to determine whether the rotational axis is in the center of the pipeline on the basis of reflections on the pipeline of the ultrasonic pulses transmitted by the first ultrasonic transmitter/receiver 44, which reflections are received with the first ultrasonic transmitter/receiver 44. If this point in time varies, then an alarm can be delivered by the signal processing means 36. It further holds true in this example that signal processing means are arranged for being able to check, on the basis of reflections on the pipeline of the ultrasonic pulses transmitted by the first ultrasonic transmitter/receiver, which reflections are received with the first ultrasonic transmitter/receiver, whether an area is scanned in which an anode is present by detecting the presence of welds whereby the anode is attached on the pipeline. To this end, with the aid of the signal processing means, for instance an image can be generated as shown in FIG. 10.

In FIG. 10, in the area H, an image is obtained which is similar to the one discussed with reference to FIG. 7d. In this example, the image extends over a large distance of the pipeline in the direction X, over which large distance different anodes have been placed. The respective anodes are visible in the positions 50 of FIG. 10. On the basis of these images, an operator can check whether an area which is scanned indeed comprises an anode. Completely analogously, the system may further be provided with a second ultrasonic transmitter/receiver 60 of the 45-degree type which is mounted on the rotor, while, in use, with the aid of the second ultrasonic transmitter/receiver, successively ultrasonic pulses are transmitted in a direction of the pipeline and while the signal processing means are arranged for being able to check whether a crack detected with the aid of the ultrasonic transmitter and the ultrasonic receiver is indeed present. The second ultrasonic transmitter/receiver can be used in a similar manner as discussed hereinabove with reference to the first ultrasonic transmitter/receiver.

The invention is by no means limited to the above-described embodiments. For instance, as already briefly indicated hereinabove, the ultrasonic transmitter and the ultrasonic receiver may also be separated from each other in a tangential direction of the rotor. All this is shown in FIG. 9a. The signals which are successively obtained on the basis of the successive pulses are shown in FIG. 9b. Now particularly the length of the crack extending in a longitudinal direction of the pipeline can be determined. Carriage is also understood to mean a carriage (transport unit) which is not provided with wheels. The carriage may, for instance, be provided with sliding surfaces which operatively slide along the inner wall of the pipeline, so that the carriage can be transported through the pipeline. Such variants are each understood to be within the framework of the invention.

1. A method for detecting a crack in a pipeline from an inside of the pipeline, wherein, with the aid of at least one ultrasonic transmitter in the pipeline, successively ultrasonic pulses are transmitted in a direction of an inner wall of the pipeline and wherein, with the aid of at least one ultrasonic receiver in the pipeline, reflections of the ultrasonic pulses on the pipeline are received, characterized in that the ultrasonic transmitter and the ultrasonic receiver are mutually separated at a distance from each other, wherein the ultrasonic transmitter and the ultrasonic receiver are moved together along the inner wall in tangential direction of the pipeline and at a distance from the inner wall for scanning the pipeline, wherein the pipeline is filled with a liquid such as water for obtaining an immersion between the ultrasonic transmitter, the ultrasonic receiver and the inner wall of the pipeline for the purpose of scanning, wherein the presence of a crack is detected on the basis of points in time at which reflections of the successive ultrasonic pulses are received.

2. The method according to claim 1, characterized in that the ultrasonic transmitter and the ultrasonic receiver are separated from each other in a longitudinal direction of the pipeline for detecting cracks of which at least a part extends in a tangential direction of the pipe.

3. The method according to claim 1, characterized in that the beam width of a wave transmitted by the ultrasonic transmitter in a direction in which the ultrasonic transmitter and the ultrasonic receiver are separated from each other is larger than a beam width in a direction perpendicular to the direction in which the ultrasonic transmitter and the ultrasonic receiver are separated from each other.

4. The method according to claim 2, characterized in that a beam width of a pulse transmitted by the ultrasonic transmitter in a longitudinal direction of the pipeline is larger than a beam width in tangential direction of the pipeline.

5. The method according to claim 2, characterized in that, with the aid of the method, cracks are detected in a pipeline on which anodes have been welded on an outer wall of the pipeline and which pipeline has been unrolled from a roll so that the cracks are expected to extend in radial direction of the pipeline.

6. The method according to claim 1, characterized in that the ultrasonic transmitter and the ultrasonic receiver are also moved in a longitudinal direction of the pipeline.

7. The method according to claim 6, characterized in that the ultrasonic transmitter and the ultrasonic receiver are moved along a helix extending in the longitudinal direction of the pipeline.

8. The method according to claim 6, characterized in that a beam width of a transmitted ultrasonic pulse near the inner wall of the pipeline in a direction from the ultrasonic transmitter to the ultrasonic receiver is larger than the distance between neighboring positions in which the ultrasonic transmitter and the ultrasonic receiver are located when they always take up a same tangential position during scanning.

9. The method according to claim 6, characterized in that the ultrasonic transmitter and the ultrasonic receiver are transported in the pipeline at a relatively high transport speed to predetermined areas where cracks are expected, wherein, during scanning of the areas, the ultrasonic transmitter and the ultrasonic receiver are moved in the longitudinal direction of the pipeline at an average scanning speed which is lower than the transport speed.

10. The method according to claim 5, characterized in that the said areas are determined by the positions of the anodes.

11. The method according to claim 1, characterized in that the size and/or the position of at least a part of the crack in radial direction of the pipeline is determined on the basis of said points in time.

12. The method according to claim 11, characterized in that the point in time of a reflection on the inner wall is taken as a reference point in time, wherein the points in time of the other reflections are determined with respect to the reference point in time for further processing or that the point in time of a reflection on the outer wall is taken as a reference point in time, wherein the points in time of the other reflections are determined with respect to the reference point in time for further processing.

13. The method according to claim 1, characterized in that the position and/or the size of at least a part of the crack in the longitudinal direction of the pipeline is determined on the basis of the momentary positions of the ultrasonic transmitter and the ultrasonic receiver in the longitudinal direction of the pipeline in which they are located inside the pipeline when ultrasonic reflections are received.

14. The method according to claim 1, characterized in that the position and/or the size of at least a part of the crack in a tangential direction of the pipeline is determined on the basis of the momentary positions of the ultrasonic transmitter and the ultrasonic receiver in the tangential direction of the pipeline in which they are located inside the pipeline when ultrasonic reflections are received.

15. The method according to claim 1, characterized in that use is made of a carriage which is transported inside the pipeline in a longitudinal direction of the pipeline, which carriage is provided with a rotor which is rotated about a rotational axis extending in the longitudinal direction of the pipeline, wherein the ultrasonic transmitter and the ultrasonic receiver are mounted on the rotor.

16. The method according to claim 15, characterized in that, further, a first ultrasonic transmitter/receiver is mounted on the rotor, wherein, with the aid of the first ultrasonic transmitter/receiver, ultrasonic pulses are transmitted in a radial direction of the pipeline and wherein, on the basis of reflections on the pipeline of the ultrasonic pulses transmitted by the first ultrasonic transmitter/receiver, which reflections are received by the first ultrasonic transmitter/receiver, it is determined whether the rotational axis is in a center of the pipeline.

17. The method according to claim 15, characterized in that, on the basis of reflections on the pipeline of the ultrasonic pulses transmitted by the first ultrasonic transmitter/receiver, which reflections are received by the first ultrasonic transmitter/receiver, it is checked whether an area is scanned where an anode is present by detecting the presence of welds whereby the anode has been attached on the pipeline.

18. The method according to claim 15, characterized in that, further, on the rotor, a second ultrasonic transmitter/receiver is mounted of the 45-degree type, wherein, with the aid of the second ultrasonic transmitter/receiver, successively ultrasonic pulses are transmitted in a direction of the pipeline and wherein, on the basis of reflections on the pipeline of the ultrasonic pulses transmitted by the second ultrasonic transmitter/receiver, which reflections are received by the second ultrasonic transmitter/receiver, it is checked whether a crack detected with the aid of the ultrasonic transmitter and the ultrasonic receiver is indeed present.

19. The method according to claim 1, characterized in that the ultrasonic transmitter and the ultrasonic receiver are separated from each other in a tangential direction of the pipeline.

20. An assembly of a pipeline and a system for detecting a crack in the pipeline from an inside of the pipeline, wherein the system is provided with a carriage which is operatively transported inside the pipeline in a longitudinal direction of the pipeline coinciding with a driving direction of the carriage and wherein the system is further provided with at least one ultrasonic transmitter and at least one ultrasonic receiver which are mounted on the carriage, characterized in that the carriage is provided with a rotor which is arranged for operatively being rotated about a rotational axis extending in the driving direction, wherein the ultrasonic transmitter and the ultrasonic receiver are mounted on the rotor and are separated at a mutual distance from each other, wherein the system is arranged for operatively successively transmitting ultrasonic pulses in a direction of an inner wall of the pipeline with the aid of the ultrasonic transmitter in the pipeline and to receive reflections of the ultrasonic pulses on the pipeline with the aid of the ultrasonic receiver in the pipeline, while, by rotation of the rotor, the ultrasonic transmitter and the ultrasonic receiver are moved together along the inner wall in tangential direction of the pipeline and at a distance from the inner wall for scanning the pipeline, wherein the pipeline has been filled with a liquid such as water for obtaining an immersion between the ultrasonic transmitter, the ultrasonic receiver and the inner wall of the pipeline for the purpose of scanning, wherein the system is further provided with signal processing means arranged for being able to detect the presence of a crack on the basis of points in time at which reflections of the successive ultrasonic pulses are received with the ultrasonic receiver.

21. The assembly according to claim 20, characterized in that the ultrasonic transmitter and the ultrasonic receiver are separated from each other in the driving direction of the carriage.

22. The assembly according to claim 20, characterized in that the beam width of a pulse transmitted by the ultrasonic transmitter in a direction in which the ultrasonic transmitter and the ultrasonic receiver are separated from each other is larger than a beam width in a direction perpendicular to the direction in which the ultrasonic transmitter and the ultrasonic receiver are separated from each other.

23. The assembly according to claim 21, characterized in that the beam width of a wave transmitted by the ultrasonic transmitter in a driving direction of the carriage is larger than the beam width perpendicular to the driving direction of the carriage.

24. The assembly according to claim 20, characterized in that the carriage is arranged for also driving in the driving direction during the rotation of the rotor so that the ultrasonic transmitter and the ultrasonic receiver are moved along a helix extending in the longitudinal direction of the pipeline.

25. The assembly according to claim 23, characterized in that a beam width of a transmitted ultrasonic pulse in the driving direction is larger than the distance between neighboring positions in which the ultrasonic transmitter and the ultrasonic receiver are located when they always take up a same tangential position during scanning.

26. The assembly according to claim 20, characterized in that, on an outer wall of the pipeline, anodes have been welded and which pipeline has been unrolled from a roll so that the cracks are expected to extend in radial direction of the pipeline.

27. The assembly according to claim 20, characterized in that the carriage is arranged for operatively transporting the ultrasonic transmitter and the ultrasonic receiver in the pipeline at a relatively high transport speed to predetermined areas where cracks are expected, wherein the carriage is arranged for moving the ultrasonic transmitter and the ultrasonic receiver in the longitudinal direction of the pipeline during scanning of the areas at an average scanning speed which is lower than the transport speed.

28. The assembly according to claim 20, characterized in that the system is arranged for operatively being able to determine the size and/or the position of at least a part of the crack in radial direction of the pipeline on the basis of said points in time.

29. The assembly according to claim 20, characterized in that the signal processing means are arranged for taking the point in time of a reflection on the inner wall as a reference point in time, wherein the points in time of the other reflections are determined with respect to the reference point in time for further processing or to take the point in time of a reflection on the outer wall as a reference point in time, wherein the points in time of the other reflections are determined with respect to the reference point in time for further processing.

30. The assembly according to claim 20, characterized in that the system is arranged for operatively being able to determine the position and/or the size of at least a part of the crack in a driving direction on the basis of the momentary positions of the ultrasonic transmitter and the ultrasonic receiver in the driving direction in which they are located inside the pipeline when ultrasonic reflections are received.

31. The assembly according to claim 20, characterized in that the system is arranged for operatively being able to determine the position and/or the size of at least a part of the crack in a tangential direction of the rotor on the basis of the momentary positions of the ultrasonic transmitter and the ultrasonic receiver in the tangential direction of the rotor in which they are located inside the pipeline when ultrasonic reflections are received.

32. The assembly according to claim 20, characterized in that the system is further provided with a first ultrasonic transmitter/receiver which is arranged for transmitting ultrasonic pulses in a radial direction of the pipeline, wherein the signal processing means are arranged for being able to determine, on the basis of reflections on the pipeline of the ultrasonic pulses transmitted by the first ultrasonic transmitter/receiver, which reflections are received with the first ultrasonic transmitter/receiver, whether the rotational axis is in a center of the pipeline.

33. The assembly according to claim 26, characterized in that signal processing means are arranged for being able to determine, on the basis of reflections on the pipeline of the ultrasonic pulses transmitted by the first ultrasonic transmitter/receiver, which reflections are received with the first ultrasonic transmitter/receiver, whether an area is scanned in which an anode is present by detecting the presence of welds whereby the anode has been attached on the pipeline.

34. The assembly according to claim 20, characterized in that the system is further provided with a second ultrasonic transmitter/receiver of the 45-degree type which is mounted on the rotor, wherein operatively, with the aid of the second ultrasonic transmitter/receiver, successively ultrasonic pulses are transmitted in a direction of the pipeline and wherein the signal processing means are arranged for checking whether a crack detected with the aid of the ultrasonic transmitter and the ultrasonic receiver is indeed present.

35. The assembly according to claim 20, characterized in that the ultrasonic transmitter and the ultrasonic receiver are separated from each other in a tangential direction of the rotor.

36. The method according to claim 16, characterized in that the pulse repetition frequency of the ultrasonic transmitter is larger than the pulse repetition frequency of the first ultrasonic transmitter/receiver.

37. The assembly according to claim 32, characterized in that the pulse repetition frequency of the ultrasonic transmitter is larger than the pulse repetition frequency of the first ultrasonic transmitter/receiver.

38. The system of the assembly according to claim 20.
